(19) United States
(12) Patent Application Publication
(10) Pub. No.: US 2018/0229999 A1
(43) Pub. Date: Aug. 16, 2018

(54) CONNECTOR FOR USE IN EQUESTRIAN EQUIPMENT, USE OF SUCH CONNECTOR AND BRIDLE COMPRISING SUCH CONNECTOR

(71) Applicant: PS of Sweden AB, Nykoping (SE)

(72) Inventors: Karin Bjarle, Stockholm (SE); Sofia Oberg, Linkoping (SE)

(21) Appl. No.: 15/892,173

(22) Filed: Feb. 8, 2018

(30) Foreign Application Priority Data
Feb. 13, 2017 (SE) 1750128-9

(51) Int. Cl. B68B 5/00; B68B 1/04

(52) U.S. Cl. CPC B68B 5/00; B68B 1/04

(57) ABSTRACT

This document discloses a connector for use in equestrian equipment, such as bridles, reins, saddles and the like. The connector comprises an outer loop, and an inner loop, which is arranged inside the outer loop. The inner loop is more resilient than the outer loop, such that a connecting member received in the inner loop is resiliently moveable and limited by the outer loop. The inner loop is formed by an inner loop forming strap comprising a resilient portion which is formed of an elastically resilient material and a non-elastic portion which is formed of an essentially non-resilient material. The resilient and non-resilient portions are juxtaposed in the longitudinal direction of the inner loop forming strap. The part of the inner loop forming strap contacting the connecting member is formed by the non-resilient portion.

### TECHNICAL FIELD

The present disclosure relates connectors for use in equestrian equipment, such as bridles, reins or saddles.

The disclosure particularly relates to a bridle for equines, such as horses, and more particularly to a bridle comprising a connector for connecting, e.g. a bit, to a cheek piece of the bridle.

### BACKGROUND

Bridles are well known and used to facilitate control of equines, such as horses. The bridle is fitted onto the head of the horse, and provides a connection for the reins and the bit.

U.S. Pat. No. 3,981,124 discloses an example of a bridle comprising a headstall, a browband, cheek pieces, a throat latch and a noseplate.

However, a bridle may, under certain circumstances, partly depending on the horse's anatomy, partly depending on the setting of the bridle, provide discomfort, pain, or even injury to the horse.

For ergonomic reasons, in particular with regard to the animal, there is a desire to provide some elasticity in relation to a bit, which is placed in the animal's mouth.

For example, in DE202009017477U1, it is proposed to position a piece of elastic material in the cheek piece, and in particular at its intersection with the browband.

However, this solution is difficult to implement, as it requires redesign of the entire bridle. Moreover, it does not allow for retrofitting.

DE2009954A discloses a bit connector providing an inner loop and an outer loop, wherein the inner loop is entirely made of an elastically resilient material and the outer loop is made of a flexible, but generally non-resilient material. The side ring of the bit is received in both inner and outer loops, such that it, when in a non-tensioned state, is elastically resiliently held by the inner loop, and, when in a sufficiently tensioned state becomes limited by the outer loop, which is non-resilient.

While elastic bit connections are not generally banned, there are various regulations which limit options for where elastic materials may be fitted.

Hence, there is a need for an improved way of providing an elastic connection between the bridle and the bit.

### SUMMARY

An object of the present disclosure is thus to provide an improved way of providing an elastic connection between the bridle and the bit. A particular object is to provide a connection which complies with existing regulations.

The invention is defined by the appended independent claims, with embodiments being set forth in the appended dependent claims, in the following description and in the following drawings.

According to a first aspect, there is provided a connector for use in equestrian equipment, such as bridles, reins, saddles and the like. The connector comprises an outer loop, and an inner loop, which is arranged inside the outer loop. The inner loop is more resilient than the outer loop, such that a connecting member received in the inner loop is resiliently moveable and limited by the outer loop. The inner loop is formed by an inner loop forming strap comprising a resilient portion which is formed of an elastically resilient material and a non-resilient portion which is formed of an essentially non-resilient material. The resilient and non-resilient portions are juxtaposed in the longitudinal direction of the inner loop forming strap. The part of the inner loop forming strap contacting the connecting member is formed by the non-resilient portion.

Through this arrangement, there is provided a connector which, as one example, may be used as a bit holder, which may provide all non-resilient material contact with the cheek ring, while still allowing some resilience in the connection between the bridle and the bit.

The connector may be used to connect to other connecting members used in equestrian equipment or elsewhere.

Moreover, it is possible to “hide” the resilient material essentially inside the buckle, whereby it is possible to retain the classical look of the bridle, which many people prefer.

The resilient portion may be arranged distally of the non-resilient portion.

The terms “distally” and “proximally” are seen from the base of the bit holder.

The resilient portion may be arranged proximally of the non-resilient portion.

A first resilient portion may be arranged distally of the non-resilient portion and a second resilient portion may be arranged proximally of the non-resilient portion.

The resilient portion or portions may comprise a rubber elastic material.

The connector may comprise a buckle.

At least one resilient portion may be arranged distally of the buckle.
Alternatively, or as a supplement, at least one resilient portion may be arranged proximally of the buckle, i.e. above the buckle.
The buckle may be connected to the inner loop forming strap and moveable relative to the outer loop forming strap.
Alternatively, the buckle may be connected to the outer loop forming strap and the inner loop forming strap may be designed to be movable past the buckle, e.g. by means of a cutout or longitudinal slit.

An outer loop forming strap may be connected at its proximal end to a base of the buckle, and with its free end to a locking mechanism of the buckle.

The inner loop forming strap may be connected at its proximal end to the base of the buckle and at its free end to the locking mechanism.

Free end portions of the outer loop forming strap and the inner loop forming strap may be separately and selectably connectable to the locking mechanism.

That is, it may be possible to connect one of the straps to the buckle without connecting the other one to the buckle.

A free end of the inner loop forming strap may be fixedly connected to a free end of the outer loop forming strap.

That is, the straps may be integrated with each other, such that both loops are formed at the same time.

The outer loop may be formed by a flexible material having low or zero resilience, such as leather, woven or non-woven fabric or a reinforced polymeric material.

The inner loop may be formed partially by a flexible material having low or zero resilience and partially by flexible material having substantial resilience.

For example, the material having substantial resilience may be a rubberized strap or a material portion formed of rubber, urethane or the like.

The inner loop may be designed such that its resilient portions, when subject to a tensional load in the longitudinal direction, expand resiliently until an outer surface of the inner loop contacts an inner surface of the outer loop, and further expansion of the inner loop is limited by the outer loop.

According to a second aspect, there is provided use of a connector as claimed in any one of the preceding claims, for connecting a cheek piece of a bridle to a cheek ring of a bit, whereby the cheek ring is resiliently received in the inner and outer loops.

It is noted that the connector may be releasably attachable to the bridle, e.g. to a cheek piece forming part of the bridle.

According to a third aspect, there is provided a cheek piece for a bridle, comprising at least one connector described above, wherein the connector is integrated with a strap member that is adapted to run between a bit and a headstall of the bridle.

According to a fourth aspect, there is provided a bridle for an equine, comprising at least one connector described above, wherein the connector forms a bit connector, which is connected to a cheek piece of the bridle and positioned such that a cheek ring of a bit is receivable in the inner and outer loops.

In the bridle, the non-resilient portion may be formed from substantially the same material type as the cheek piece.

### BRIEF DESCRIPTION OF THE DRAWINGS

FIG. 1 schematically illustrates a horse wearing a bridle.

FIG. 2 schematically illustrates the bridle of FIG. 1.

FIGS. 3a-3c schematically illustrate a bit connector 41, which may be used in the bridle according to FIGS. 1 and 2.

FIGS. 4a-4b schematically illustrate another version of a bit connector.

### DETAILED DESCRIPTION

In the following description, directions such as forward, backward, rear, front, side, up, above, down and below are to be understood based on a horse standing up and with its head facing forward.

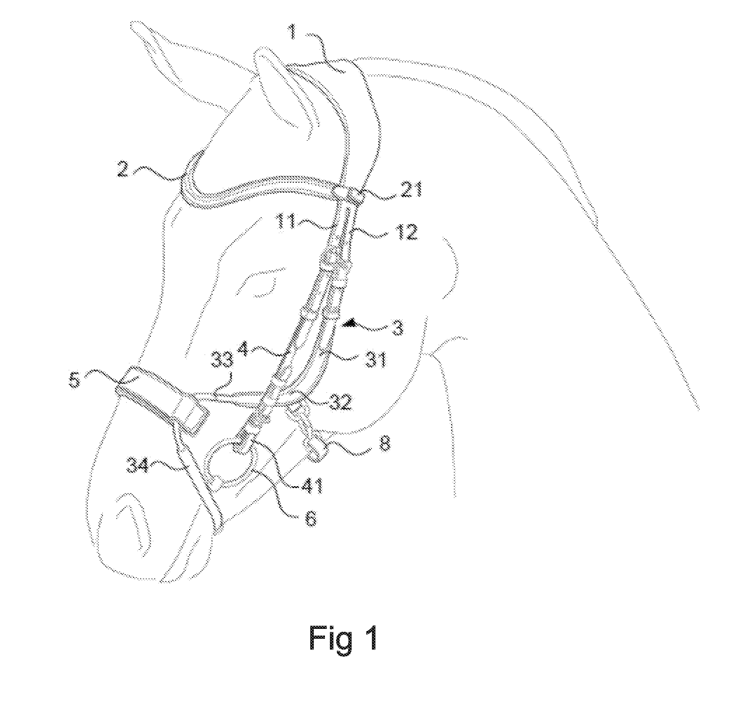

FIG. 1 illustrates a head of a horse wearing a bridle according to the present disclosure. The bridle comprises a headstall 1, a browband 2, a cheek piece 4 and a noseband 3 on each side of the head, a bit connector 41, a bit ring 6, 6′ and a bit (not shown), a noseplate 5 and a throat latch 8. The bridle may be formed of straps of one or more materials, such as leather, fabric or reinforced polymer material.

The headstall 1 comprises an elongate part, end portions of which connect to the cheek pieces 3 and 4 on the sides of the head, e.g. slightly below/behind the horse's eye.

The end portions may, but need not, present a respective bifurcation, thus providing a pair of sub end portions 11, 11′ and 12, 12′ at each side of the horse's head. These sub end portions 11, 11′ and 12, 12′ may form part of, or connect to, a respective cheek piece 4 and 3.

That is, an upper sub end portion 11 may form part of, or connect to, a cheek piece 4 and a lower sub end portion 12 may form part of, or connect to, a noseband 3.

In the illustrated example, the noseband 3 presents a first portion 31, 31′ which is substantially straight and parallel +/− less than 10° with the cheek piece 4. The noseband 3 may further present a second portion 32, 32′, which is curved upwardly, such that it crosses the cheek piece 4, for example below the latter.

At the curved portion 32, the throat latch 8 may be releasably attached.

The curved portion 32 may present an increased width as compared to the first portion 31. Such increased width may be 125%-200% of the width of the first portion 31.

Following the curved portion 32, essentially above a bit or bit ring 6 and near the nasal bridge of the horse, there may be provided a noseplate attachment portion 33, 33′.

The noseplate 5 may be slidably attached to the noseplate attachment portion 33, such that the height position of the noseplate 5 is adjustable.

The noseplate attachment portion 33 may present a substantially circular cross section, such that substantially no, or very little, torque can be transferred from the noseplate 5 to the noseplate attachment portion 33.

The noseplate attachment portion 33 may be plastically deformable. For example, this portion may comprise a core of a metal wire, engulfed in a polymeric material and optionally coated with a fabric or leather enclosure.

Forward of the noseplate attachment portion 33, there may be provided a lower noseplate 34, extending below the horse's chin and forward of the bit.

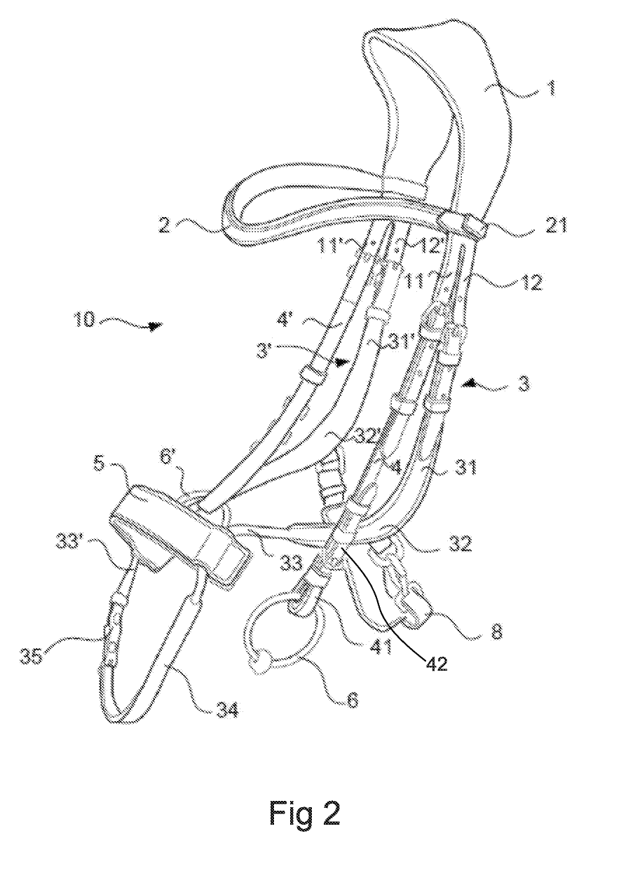

The lower noseband closure 34 will connect with the corresponding structure under the horse's chin. Such connection may be length adjustable. For example, a buckle arrangement 35 as illustrated in FIG. 2 may be provided.

It is recognized that the bridle comprises the cheek pieces 4 running along the respective cheek of the horse, and cross members, extending between the side pieces. The cross members include the headstall 1, the browband 2, the noseplate 5 and the throat latch 8. Optionally, the cross members may include one or more chin pieces, adapted to extend below the horse's chin. Moreover, a noseband may be arranged instead of the noseplate 5. Such a noseband may extend all the way around the horse's nose, and thus form e.g. both a noseplate and a chin piece.

The cross members may be generally elongate parts, each extending between respective connectors or connecting points, to which the cross members are directly or indirectly connected to the cheek pieces.

The inventive concept will be described with reference to use as a bit connector. However, it is understood that the connector may be used for other purposes as well.

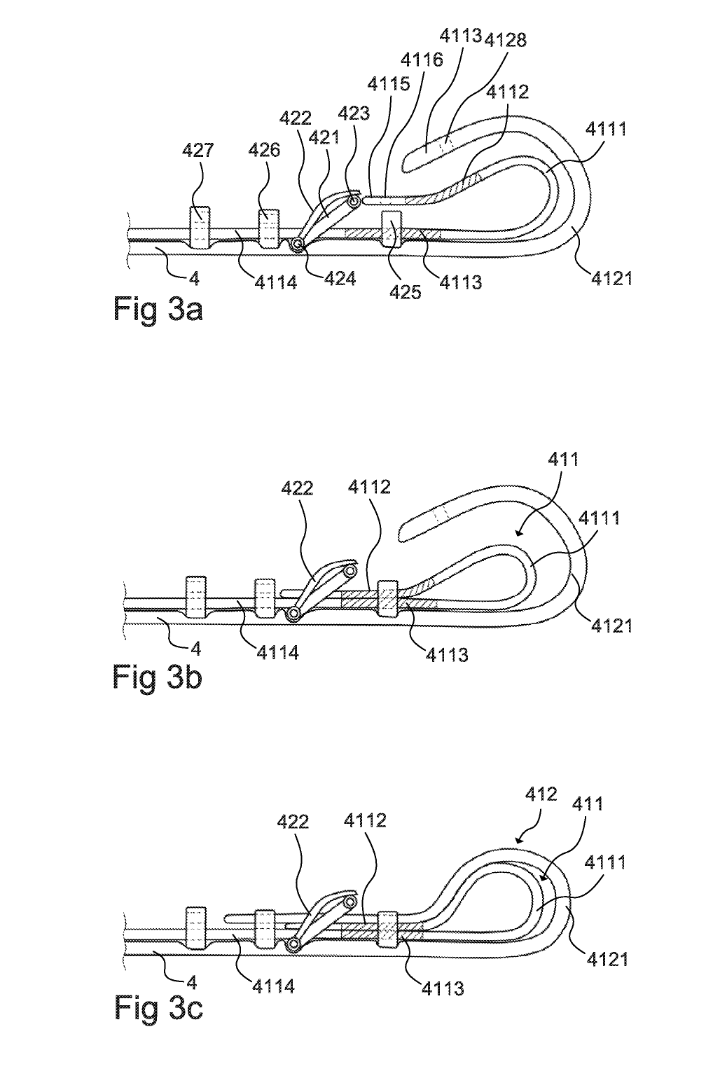

Referring to FIGS. 3a-3c, there is disclosed a first version of a bit connector 41. Generally, a bit connector comprises a loop 411, 412, in which a cheek ring of a bit is releasably received.

The loop may be formed by an elongate, flexible member, having a proximal portion, where a buckle is attached and a free portion, a distal portion of which being adapted to engage the buckle to close the loop.

The loop comprises an inner loop 411 and an outer loop 412, where the inner and outer loops are arranged substantially in a common plane, with the inner loop 411 being positioned radially inside the outer loop 412.

The inner loop may be formed by an inner loop forming strap 4111, 4112, 4113, 4114. Likewise, the outer loop may be formed by an outer loop forming strap 4121.

The outer loop forming strap 4121 may be connected to, or form part of, a strap forming the cheek piece 4.

The inner loop forming strap 4111, 4112, 4113, 4114, 4115 may, at its proximal end, be attached to, or integrated with, the outer loop forming strap 4121.

The outer loop forming strap is made from a flexible, but substantially non-resilient material. Typically, such material may be leather, but a non-resilient woven or non-woven fabric may be used, or even a reinforced polymeric material, or rope.

The inner loop forming strap comprises at least two joined together material portions: a non-resilient material portion 4111 and one or two resilient material portions 4112, 4113.

“Resilient” means elastically resilient, i.e. having the capability to expand when under tension and retake original shape when tension is released.

The non-resilient material portion 4111 and the one or two resilient material portions 4112, 4113 may be joined by stitching, rivets, clamps and/or by glue.

The non-resilient material portion 4111 and the one or two resilient material portions 4112, 4113 are juxtaposed as seen in a longitudinal direction of the inner loop forming strap 4111, 4112, 4113, 4114, 4115.

A distal portion 4115 of the inner loop forming strap may also be non-resilient.

The inner loop is, to at least 50%, preferably 60%, 70%, 80%, 90%, of its circumferential length non-resilient, e.g. by being formed of the non-resilient material portion 4111, such that the cheek ring received in the inner loop only contacts the non-resilient material portion 4111,

The loops 411, 412 are openable, to allow attachment, or removal of, the cheek ring of the bit. To this end, there may be provided a buckle 42.

The buckle may be integrated with the cheek piece 4, at the proximal portion of the straps 4111, 4112, 4113, 4121, and may comprise a frame 421, 423, a prong 422 for insertion into a hole 4116, 4128 of the distal portions, and optionally a bar 424, by which the prong 422 may be connected to the frame 421, 423, such that the prong 422 is pivotable relative to the bar. It is noted that each of the straps may have multiple holes 4116, 4128. Optionally, the buckle 42 may be provided with a chape (not shown) for attachment to the cheek piece 4. The buckle 42 may be supplemented by one or more keepers 425, 426, 427. At least one keeper 425 may be arranged on the loop side of the buckle 42 and at least one keeper 426, 427 may be arranged on the strap cheek piece side of the buckle 42.

A first resilient material portion 4112, if any, may be arranged distally of the non-resilient material portion 4111 forming the loop 411. This first resilient material portion 4112 may be arranged such that it, when the inner loop 411 is formed by connection of the outermost portion 4115 to the buckle 42, at least partially overlaps a distal side keeper 425.

The second resilient material portion 4113, if any, may be arranged proximally of the non-resilient material portion 4111 forming the loop 411. This second resilient material portion 4113 may be arranged such that it, when the inner loop 411 is formed by connection of the outermost portion 4115 to the buckle 42, at least partially overlaps a distal side keeper 425.

In an embodiment with two resilient material portions, as illustrated in FIGS. 3a-3c, both resilient material portions 4112, 4113 may at least partially overlap a distal side keeper 425.

FIG. 3a illustrates the bit connector 41 in an open state, where a cheek ring of a bit can be received in the loops 411, 412.

The loops 411, 412 may then be closed as follows.

The strap forming the inner loop 411 is inserted through the distal side keeper 425 and its distal portion 4115 is inserted through the buckle frame 421, 423 and its prong 422 caused to engage the hole 4116.

At this point, the inner loop 411 has been formed, but the outer one remains open, as can be seen in FIG. 3b.

Subsequently, the distal portion of the outer loop forming strap 4121 is introduced into the distal side keeper 425 and through the frame 421, 423, whereby one of its holes 4128 is engaged by the prong 422. The remaining free end of the strap 4121 is introduced into one or both of the proximal side keepers 426, 427.

At this point, also the outer loop 412 is closed, as can be seen in FIG. 3c.

It is noted that the inner loop forming strap 4111, 4112, 4113, 4114, 4115 need not be connected to the buckle 42. That is, the inner loop 411 need not be formed. In such case, the bit connector will operate as a conventional bit connector, without the resilient function. Hence, this version provides a selectable resilient function.

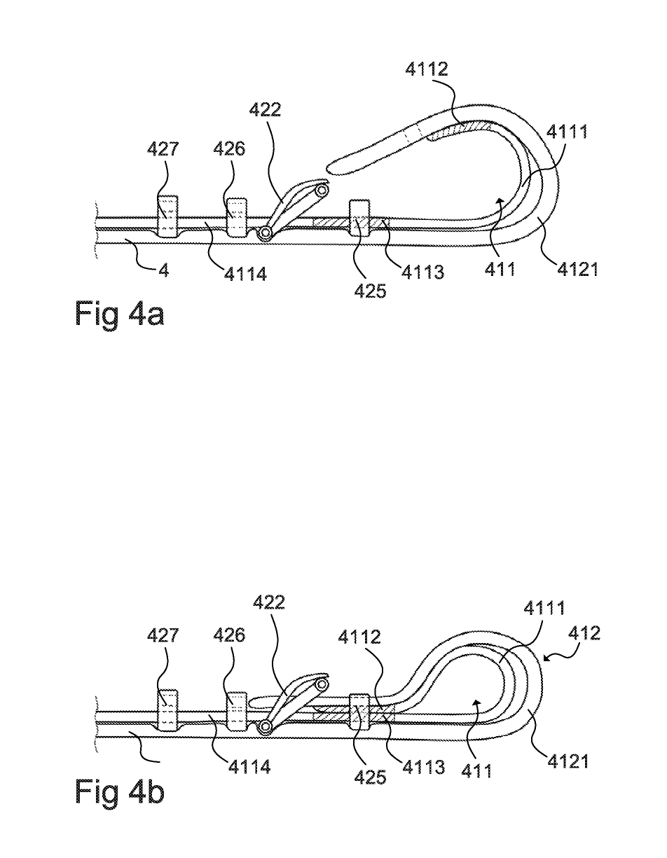

Referring to FIGS. 4a-4b, there is disclosed another version of a bit connector, wherein the resilient function is not selectable. That is, the inner loop 411 will always be formed.

The bit connector 42 according to FIGS. 4a-4b may be designed in accordance with that disclosed in FIGS. 3a-3c with the exception that the distal portion of the inner loop forming strap is attached to the distal portion of the outer loop forming strap 4121, such that when the latter is introduced into the buckle, both loops 411, 412 will be formed simultaneously.

Also in this version, the inner loop forming strap may comprise a non-resilient material portion 4111 forming most of the loop 411 and one or more resilient material portions 4113, 4112 arranged proximally and/or distally of the non-resilient material portion 4111.

For example, a distally arranged resilient material portion 4112 may be connected at one of its ends to a free portion of the outer loop forming strap 4121 and at its other end to the distal portion of the non-resilient material portion 4111 of the inner loop forming strap, such that there is a resilient connection between the distal portions of the loop forming straps.

Likewise, a proximally arranged resilient material portion 4113 may be arranged as described with reference to FIGS. 3a-3c.

Referring to FIG. 4a, the bit connector is illustrated in its open state.

In order to form the loops 411, 412, the free end of the outer loop forming strap 4121 is introduced into the distally arranged keeper 425 (if any) and then into the frame 421, 423 of the buckle, whereby the prong 422 is caused to engage one of the holes of the distal end of the strap 4121. Subsequently, the distal portion of the strap 4121 is inserted into one or both of the proximally arranged keepers 426, 427.

In an alternative embodiment, the resilient material 4112, 4113 may extend along the entire length of the inner loop forming strap, but its resilience may be disabled at the non-resilient portion 4111, e.g. by it being attached to an overlapping piece of non-resilient, but flexible material.

As described above, the resilient portions may be arranged distally of the buckle. However, it is possible also to arrange the resilient portion at the buckle or even proximally of the buckle. The inner loop forming strap may thus be moveable relative to the outer loop forming strap over a substantial part of its length.

In a first example, the resilient portion of the inner loop forming strap may be formed proximally of the buckle, whereby the buckle, e.g. at its base, is attached to the inner loop forming strap. Thus, the buckle may be movable relative to the outer loop forming strap.

As an example, where the connector is used as a bit holder, the resilient portion of the inner loop forming strap may be arranged anywhere along the length of a cheek piece. For example, it may be arranged at the connection to the headpiece or to the browband. Alternatively, it may be arranged at a central portion of the cheekpiece. As yet another alternative, it may be arranged closer to the connector than to the headpiece connection.

In a second example, the resilient portion of the inner loop forming strap may be formed proximally of the buckle, whereby the inner loop forming strap is designed to be movable relative to the buckle. For example, a cutout or a longitudinal slit may be provided in the area where the buckle pin is to be situated, such that the inner loop forming strap may move independently of the buckle, or at least such that there is no positive locking between the buckle and the inner loop forming strap.

1. A connector for use in equestrian equipment, such as bridles, reins, saddles and the like, comprising:
an outer loop, formed by an outer loop-forming strap, and
an inner loop, formed by an inner loop-forming strap, which is arranged inside the outer loop,
wherein the inner loop is more resilient than the outer loop, such that a connecting member received in the inner loop is resiliently moveable and limited by the outer loop,
a buckle, by means of which a distal portion of the outer loop forming strap is openably connectable with a proximal portion of the outer loop forming strap, to form said outer loop,
characterized in that
the inner loop forming strap comprises a resilient portion which is formed of an elastically resilient material and a non-elastic portion which is formed of an essentially non-resilient material,
the resilient and non-resilient portions are juxtaposed in the longitudinal direction of the inner loop forming strap, and
the part of the inner loop forming strap contacting the connecting member is formed by the non-resilient portion.

2. The connector as claimed in claim 1, wherein the resilient portion is arranged distally of the non-resilient portion, as seen along the inner loop forming strap.

3. The connector as claimed in claim 1, wherein the resilient portion is arranged proximally of the non-resilient portion, as seen along the inner loop forming strap.

4. The connector as claimed in claim 1, wherein a first resilient portion is arranged distally of the non-resilient portion and wherein a second resilient portion is arranged proximally of the non-resilient portion, as seen along the inner loop forming strap.

5. The connector as claimed in claim 1, wherein the resilient portion or portions comprise a rubber elastic material.

6. The connector as claimed in claim 1, wherein the resilient portion is arranged distally of the buckle, as seen along the inner loop forming strap.

7. The connector as claimed in claim 1, wherein the resilient portion is arranged proximally of the buckle, as seen along the inner loop forming strap.

8. The connector as claimed in claim 1, wherein the buckle is connected to the inner loop forming strap and moveable relative to the outer loop forming strap.

9. The connector as claimed in claim 1, wherein the buckle is connected to the outer loop forming strap and wherein the inner loop forming strap is designed to be movable past the buckle, e.g. by means of a cutout or longitudinal slit.

10. The connector as claimed in claim 1, wherein the outer loop forming strap is connected at its proximal end at a base of the buckle, and its free end is connectable to a locking mechanism of the buckle.

11. The connector as claimed in claim 10, wherein the inner loop forming strap is connected at its proximal end at the base of the buckle and its free end is connectable to the locking mechanism.

12. The connector as claimed in claim 10, wherein free end portions of the outer loop forming strap and the inner loop forming strap are separately and selectably connectable to the locking mechanism.

13. The connector as claimed in claim 1, wherein a free end of the inner loop forming strap is fixedly connected to a free end of the outer loop forming strap.

14. The connector as claimed in claim 1, wherein the outer loop is formed by a flexible material having low or zero resilience, such as leather, woven or non-woven fabric or a reinforced polymeric material.

15. The connector as claimed in claim 1, wherein the inner loop is formed partially by a material having low or zero resilience and partially by material having substantial resilience.

16. The connector as claimed in claim 1, wherein the inner loop is designed such that its resilient portions, when subject to a tensional load in the longitudinal direction, expand resiliently until an outer surface of the inner loop contacts an inner surface of the outer loop, and further expansion of the inner loop is limited by the outer loop.

17. Use of a connector as claimed in claim 1, for connecting a cheek piece of a bridle to a cheek ring of a connecting member, whereby the cheek ring is resiliently received in the inner and outer loops.

18. A cheek piece for a bridle, comprising at least one connector as claimed in claim 1, wherein the connector is integrated with a strap member that is adapted to run between a connecting member and a headstall of the bridle.

19. A bridle for an equine, comprising at least one connector as claimed in claim 1, wherein the connector forms a bit connector, which is connected to a cheek piece of the bridle and positioned such that a cheek ring of a bit is receivable in the inner and outer loops.

20. The bridle as claimed in claim 19, wherein the non-resilient portion is formed from substantially the same material type as the cheek piece.
